(19) United States
(12) Patent Application Publication
(10) Pub. No.: US 2009/0051287 A1
(43) Pub. Date: Feb. 26, 2009

(54) Reflector Lamp

(76) Inventors: Axel Bunk, Munchen (DE); Christa Bunk, Munchen (DE); Frank Glockler, Schernfeld (DE); Christoph Krieglmeyer, Hitzhofen/Hofstetten (DE)

Correspondence Address: OSRAM SYLVANIA INC, 100 ENDICOTT STREET, DANVERS, MA, 01923, US

(21) Appl. No.: 11/992,049

(22) PCT Filed: Sep. 13, 2006
(86) PCT No.: PCT/EP2006/066330

§ 371 Date: Mar. 14, 2008

(30) Foreign Application Priority Data
Sep. 14, 2005 (DE) 20 2005 014 516.5

(51) Int. Cl. H01K 1/32

(52) U.S. Cl. 313/579

(57) ABSTRACT

A reflector lamp, in particular a halogen reflector lamp, has a light-transmitting lamp vessel, in which at least one luminous member is accommodated, at least one vessel section of the lamp vessel being provided with a reflective coating. According to the invention, the reflective coating has an interference filter, which is substantially impervious to light in the visible wavelength range and has defined transmission and reflection properties for light in the infrared wavelength range.

### TECHNICAL FIELD

The invention relates to a reflector lamp in accordance with the precharacterizing clause of patent claim 1.

### PRIOR ART

In principle, the reflector lamp according to the invention can be used in a large number of lamp systems. The main application area of the reflector lamp, however, should be in halogen reflector lamps for general lighting, for example for ceiling-mounted luminaires or recessed furniture luminaires, flexible light systems, signaling systems or radiators.

Such a reflector lamp is known, for example, from DE 103 18 051 A1 by the Applicant. These conventional halogen reflector lamps have a light-transmitting lamp vessel which is sealed at one end and has an incandescent filament arranged therein. In comparison with a conventional reflector lamp, a vessel section of the lamp vessel is provided with a light-reflective coating in such halogen reflector lamps. The light-reflective coating in this solution is in the form of a metallic coating consisting of aluminum or silver since such coatings have a high reflectance essentially for all light wavelengths. This known design is substantially more simple than conventional reflector lamps having a reflector which is formed by a parabolic or ellipsoidal glass cap consisting of pressed glass and having an integral lamp, for example a halogen incandescent lamp, which is fixed in the optical axis of the reflector. As a result, such reflector lamps have an extremely compact design and require a minimum amount of installation space during fitting.

One disadvantage with such reflector lamps is firstly the fact that the transmission and reflection properties of the metallic specular layers are established over a wide spectral range, the metallic specular layer having a high reflectance for light in the visible wavelength range and also for light in the infrared wavelength range and, as a result, the majority of the radiant heat leaving the reflector lamp in the light exit direction. As a result, thermally sensitive objects which the radiation from the lamp strikes may be damaged. Furthermore, it is disadvantageous that such metallic specular layers in individual cases do not have sufficiently high thermal stability and, in particular in hot luminaires which are spatially restricted, vaporize over the lamp's life or diffuse into the glass of the lamp vessel. As a result, the reflective effect of the reflective coating is decreased severely over the lamp's life. For this reason, it is necessary to protect the metallic specular layers by additional protective layers, for example consisting of ruthenium, against oxidation given a high thermal load. Owing to the protective layers required, the coating process used for producing such reflector lamps is complex and cost-intensive. It has also been shown that the reflectance values of the metallic reflective coatings consisting of aluminum or silver often do not meet the stringent requirements for the reflective effect.

### DESCRIPTION OF THE INVENTION

The invention is based on the object of providing a reflector lamp, in the case of which it is made possible for the transmission and reflection properties for light in the infrared wavelength range to be set in a defined manner with improved thermal stability and reflective effect of the reflective coating for light in the visible wavelength range in comparison with conventional solutions.

This object is achieved according to the invention by the features of claim 1. Particularly advantageous embodiments of the invention are described in the dependent claims.

The reflector lamp according to the invention has a light-transmitting lamp vessel, in which at least one luminous means is accommodated, a vessel section of the lamp vessel being provided with a reflective coating. According to the invention, the reflective coating has an interference filter (dichroitic filter), which is substantially impervious to light in the visible wavelength range and has defined transmission and reflection properties for light in the infrared wavelength range. Owing to the interference filter, it is possible to set the spectral properties of the reflective coating and to match the thermal effect in the emission direction of the lamp such that, for example, thermally sensitive objects which radiation from the lamp strikes are not damaged or, in the case of a recessed ceiling-mounted lamp, base-side overheating and shortening of the life of the reflector lamp are prevented, in comparison with the prior art in accordance with DE 103 18 051 A1 with a metallic coating. Furthermore, the oxide layers of the interference filter are substantially more thermally stable than metals, with the result that they do not vaporize over the lamp's life or diffuse into the glass of the lamp vessel, in particular in spatially restricted, hot luminaires. As a result, it is not necessary to protect the metallic specular layers against oxidation by additional protective layers given a high thermal load. Owing to the structure of the layers of the interference filter, furthermore, it is possible to achieve higher reflectances for the reflector lamp. As a result, the reflector lamp according to the invention meets the requirements for the reflective effect even at high temperatures, for example caused by the increasing miniaturization of such lamps.

In accordance with one particularly preferred exemplary embodiment, the reflective coating has an average reflectance of over 90% for light in the visible wavelength range, with the result that the reflector lamp has a high degree of optical efficiency in the desired visible light spectrum.

It has proven to be particularly advantageous if the reflective coating is applied to the outer circumference of the vessel section. Owing to the outer coating, the interference filter is not subjected to the corrosive effect of the filling in the lamp vessel, for example a halogen filling, and is subjected to less thermal load with a simplified coating process.

In accordance with one preferred exemplary embodiment of the invention, the interference filter has a plurality of layers having a low optical refractive index and layers having a high optical refractive index.

The layers having a low optical refractive index are preferably SiO₂ layers, and the layers having a high optical refractive index are preferably TiO₂, Nb₂O₅, Ta₂O₅, ZrO or Al₂O₃ layers. The interference filter coating can take place by means of coating processes known from the general prior art, for example by means of a PVD or CVD vacuum coating process or a dipping process.

The interference filter is preferably optimized such that a first filter edge is preferably in a wavelength range of from approximately 360 nm to 440 nm, preferably at 410 nm. As a result, a high proportion of the radiation is emitted in the visible wavelength range by the lamp, with the result that an improved degree of optical efficiency of the reflector lamp is achieved.

In accordance with one preferred embodiment of the invention, the interference filter forms a broadband mirror coating, which is optimized such that a second filter edge is in the infrared wavelength range, in particular in a wavelength range of from 1200 nm to 1400 nm, preferably at 1350 nm. With this solution which is suitable, for example, for recessed ceiling-mounted luminaires, the temperature load on the luminaire is reduced since the majority of the infrared portion of the radiation (thermal radiation) is reflected out of the luminaire.

In this variant, the layers having a low optical refractive index preferably essentially have a layer thickness in the range of from approximately 80 nm to 190 nm, and the layers having a high optical refractive index preferably essentially having a layer thickness in the range of from approximately 50 nm to 125 nm and are arranged alternately. In this case, the interference filter preferably comprises 48 layers.

In accordance with one further exemplary embodiment of the reflector lamp, the interference filter forms a cold-light mirror coating, which is optimized such that the reflectance for light in the infrared wavelength range is, on average, less than 20%. In this solution, the thermal radiation of the lamp which is radiated by the reflective coating from the lamp vessel into the room is further reduced since the reflective coating is largely pervious to thermal radiation, with the result that this thermal radiation can leave the reflector lamp to the rear, i.e. in the direction of the base. As a result, even in the case of very thermally sensitive objects, damage as a result of radiation emitted by the lamp is avoided.

In one variant according to the invention, the interference filter forms a medium mirror coating, which is optimized such that the reflectance for light in the infrared wavelength range is, on average, less than 50%. As a result, the thermal radiation of the reflector lamp which is radiated by the reflective coating from the lamp vessel into the room is reduced such that damage to thermally sensitive objects which the radiation from the lamp strikes is prevented with only a low thermal load on the luminaire.

A sealed end section of the lamp vessel is preferably in the form of a base in order to ensure dimensions of the reflector lamp which are as small as possible without any additional components.

In one preferred exemplary embodiment, the luminous means has at least one incandescent filament. The incandescent filament is preferably aligned axially in the lamp vessel. As a result, the incandescent filament can be inserted into the lamp neck of the lamp vessel more easily. Furthermore, in comparison with a horizontal arrangement of the incandescent filament, the undesirable emission into the reflector neck is minimized in the case of the axial arrangement of the incandescent filament and, as a result, the degree of optical efficiency of the reflector lamp is further improved.

In accordance with one first variant of the reflector lamp with an axial reflector, the reflective coating is arranged substantially annularly on a paraboloid vessel section, which adjoins the base, of the lamp vessel and/or on the lamp neck. As a result, defined light emission is achieved in the direction of the longitudinal axis of the lamp vessel. Owing to the paraboloid reflective section, the reflector lamp has a high degree of optical efficiency.

In this variant, the reflective coating preferably extends at least in sections as far as over longitudinal sides of the base, with the result that undesirable parasitic light emitted via the base is avoided.

In accordance with one alternative embodiment of the invention with a side reflector, the reflective coating extends over a maximum of 50 percent of the circumference of the lamp vessel. As a result, light shadowing is avoided by the reflective coating and a defined light emission of the lamp is achieved transversely to the longitudinal axis of the lamp vessel.

In order to avoid undesirable parasitic light emissions of the base and to further improve the degree of optical efficiency of the reflector lamp, the reflective coating preferably extends at least in sections as far as into a region of the base.

In one exemplary embodiment with a side reflector, the incandescent filament is preferably arranged in the lamp vessel parallel to the longitudinal axis of the lamp vessel such that it is offset in the direction of the reflective coating. As a result, the incandescent filament is surrounded by the reflective coating such that it is arranged in the region of the focal point of the reflective coating, and the directional light emission in the direction transverse to the longitudinal axis of the lamp vessel is further improved.

### BRIEF DESCRIPTION OF THE DRAWINGS

The invention will be explained in more detail below with reference to preferred exemplary embodiments. In the drawings:

FIG. 1 shows a front view of a first exemplary embodiment of a reflector lamp according to the invention having an axial reflector;

FIG. 2 shows a front view of a second exemplary embodiment of a reflector lamp according to the invention having a side reflector;

FIG. 3 shows a side view of the reflector lamp shown in FIG. 2;

FIG. 4 shows the reflectance curve of the interference filter coating shown in FIGS. 1 to 3;

FIG. 5 shows the reflectance curve of a reflector lamp having an interference filter coating in the form of a medium mirror coating, and

FIG. 6 shows the reflectance curve of a reflector lamp having an interference filter coating in the form of a cold-light mirror coating.

### PREFERRED EMBODIMENT OF THE INVENTION

The invention will be explained below with reference to a halogen reflector lamp with a base at one end and using low-volt technology, as is used, for example, in general lighting in large numbers. As has already been mentioned at the outset, the reflector lamp according to the invention is in no way restricted to such lamp types, however.

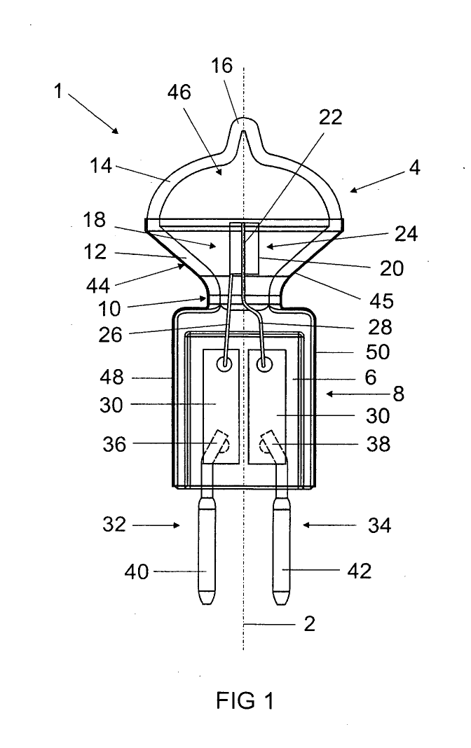

With reference to FIG. 1, a first exemplary embodiment of a reflector lamp according to the invention having an axial reflector will first be explained.

FIG. 1 shows a reflector lamp in the form of a low-volt halogen reflector lamp 1 having a lamp vessel 4, which consists of quartz glass and is rotationally symmetrical about a lamp longitudinal axis 2, a base 8 of the GY6.35 type being formed at the lower (in FIG. 1) end section of the lamp vessel 4 by means of a pinch seal 6, via which base the halogen reflector lamp 1 can be inserted into a lampholder (not illustrated). The pinch seal 6 merges with a substantially paraboloid vessel section 12 of the lamp vessel 4, which vessel section 12 widens in the form of a funnel, via an approximately cylindrical lamp neck 10. That end section of the lamp vessel 4 which is remote from the base 8 is formed by a dome-shaped bowl 14, which has an exhaust tube attachment 16 arranged diametrically with respect to the pinch seal 6, to which exhaust tube attachment 16 an exhaust tube was attached during production of the lamp 1 in order to evacuate the interior of the lamp vessel and to fill it with a halogens-containing filling gas. After filling, the exhaust tube was removed and the exhaust tube attachment 16 was fused closed. The quartz glass of the lamp vessel 4 is provided with ultraviolet radiation-absorbing dopants and is designed to be axially symmetrical with respect to its longitudinal axis 2. A luminous means 18 is arranged in the lamp vessel 4, said luminous means 18 being in the form of an incandescent filament 20 consisting of tungsten wire in the exemplary embodiment described. The incandescent filament 20 is in the form of an axial filament with an inner return line, in the case of which an end section 22 of the incandescent filament 20 is passed centrally through an approximately cylindrical filament base body 24. As a result, the filament 20 has a reduced diameter and can be inserted into the lamp vessel 4 through the lamp neck 10 during manufacture. Furthermore, the inner return line, opposite an end section 22 of the filament 20 which is passed back on the outside, prevents shadowing by means of the end section 22 during operation of the lamp 1, with the result that a uniform light emission characteristic for the reflector lamp 1 is ensured. Furthermore, in the case of the axial arrangement of the incandescent filament, in comparison with a horizontal arrangement of the incandescent filament 20, the undesirable emission into the lamp neck 10 is minimized and, as a result, the degree of optical efficiency of the reflector lamp 1 is improved. The inner power supply lines 26, 28 of the filament 20 are formed directly by the two end sections of the filament wire and are in each case welded to a molybdenum foil 30, which is embedded in a gas-tight manner in the pinch seal 6 and, in turn, is connected to an outer power supply line 32, 34. Those ends 36, 38 of the outer power supply lines 32, 34 which are welded to the molybdenum foils 30 are bent and flattened and consist of molybdenum, whereas their ends which are passed out of the pinch seal 6 are connected to contact pins 40, 42 consisting of nickel and having a greater diameter than the outer power supply lines 32, 34.

The funnel-shaped vessel section 12 of the lamp vessel 4, as shown in FIG. 1, is provided circumferentially with a reflective coating 44 (only indicated in order to be able to see the interior of the lamp), the bowl 14, which is remote from the base 8, of the lamp vessel 4 forming a light exit opening 46. Furthermore, the reflective coating 44 extends over longitudinal sides 48, 50 of the base 8, with the result that undesirable parasitic light emitted via the base 8 is avoided. The light-emitting filament base body 24 of the incandescent filament 20 is completely surrounded by the funnel-shaped vessel section 12 of the lamp vessel 4, with the result that the incandescent filament 20 is covered by the reflective coating 44. As a result, the radiation produced by the incandescent filament 20 is deflected by the reflective coating 44 at an emission angle of approximately 30 degrees with respect to the longitudinal axis 2 of the reflector lamp 1 and directional light emission is achieved.

According to the invention, the reflective coating 44 has an interference filter (dichroitic filter), which is substantially impervious to light in the visible wavelength range and has defined transmission and reflection properties for light in the infrared wavelength range. Owing to the interference filter 44, it is possible to set the spectral properties of the reflective coating 44 and to match the thermal effect in the emission direction of the lamp 1 such that, for example, thermally sensitive objects which radiation from the lamp 1 strikes are not damaged or, in the case of recessed ceiling-mounted lamps, base-side overheating and shortening of the life of the reflector lamp 1 are prevented. Furthermore, the oxide layers of the interference filter 44 are substantially more thermally stable than metals, with the result that the reflective coating 44 has a high degree of thermal stability and, in particular in spatially restricted, hot luminaires, does not vaporize over the lamp's life or diffuse into the glass of the lamp vessel 4. As a result, the reflector lamp 1 meets the requirements for the reflective effect even at high temperatures, for example caused by the increasing miniaturizing of such lamps. In the exemplary embodiment shown, the reflective coating 44 is applied to an outer circumference 45 of the vessel section 12. Owing to the outer coating 44, the interference filter 44 is not subjected to the corrosive effect of the halogen filling in the lamp vessel 4 and is subjected to less thermal load with a simplified coating process. The interference filter coating 44 comprises a plurality of layers having a low optical refractive index and layers having a high optical refractive index, which layers are applied to the vessel section 12 of the lamp vessel 4 and the longitudinal sides 48, 50 of the base 8 by means of coating processes known from the general prior art, for example using a PVD or CVD vacuum coating process or a dipping process. The layer thickness of the reflective coating 44 can be controlled, for example, via the duration of the coating process.

In the exemplary embodiment shown, the interference filter coating 44 in accordance with table 1 comprises in total 48 interference layers comprising, alternately, layers having a low optical refractive index and layers having a high optical refractive index, said layers consisting of metal oxides, in which case the layers having a low optical refractive index being SiO₂ (silicon dioxide) and the layers having a high optical refractive index being TiO₂ (titanium dioxide). The interference layers, starting with layer No. 1, are arranged on the outer surface 45 of the vessel section 12 and the longitudinal sides 50, 52 of the base 8, the layers 1 to 48 directly following one another and forming the reflective coating 44.

TABLE 1
Structure of the interference filter coating

| | | Approx. layer |
|---|---|---|
| Layer No. | Type of layer | thickness [nm] |
| 1 | TiO₂ | 52.6 |
| 2 | SiO₂ | 82.9 |
| 3 | TiO₂ | 52.6 |
| 4 | SiO₂ | 82.9 |
| 5 | TiO₂ | 52.6 |
| 6 | SiO₂ | 82.9 |
| 7 | TiO₂ | 52.6 |
| 8 | SiO₂ | 82.9 |
| 9 | TiO₂ | 52.6 |
| 10 | SiO₂ | 82.9 |
| 11 | TiO₂ | 52.6 |
| 12 | SiO₂ | 82.9 |
| 13 | TiO₂ | 71.7 |
| 14 | SiO₂ | 113.0 |
| 15 | TiO₂ | 71.7 |
| 16 | SiO₂ | 113.0 |
| 17 | TiO₂ | 71.7 |
| 18 | SiO₂ | 113.0 |
| 19 | TiO₂ | 71.7 |
| 20 | SiO₂ | 113.0 |
| 21 | TiO₂ | 71.7 |
| 22 | SiO₂ | 113.0 |
| 23 | TiO₂ | 71.7 |
| 24 | SiO₂ | 113.0 |
| 25 | TiO₂ | 95.7 |
| 26 | SiO₂ | 150.7 |
| 27 | TiO₂ | 95.7 |
| 28 | SiO₂ | 150.7 |
| 29 | TiO₂ | 95.7 |
| 30 | SiO₂ | 150.7 |
| 31 | TiO₂ | 95.7 |
| 32 | SiO₂ | 150.7 |
| 33 | TiO₂ | 95.7 |
| 34 | SiO₂ | 150.7 |
| 35 | TiO₂ | 95.7 |
| 36 | SiO₂ | 150.7 |
| 37 | TiO₂ | 120.0 |
| 38 | SiO₂ | 188.4 |
| 39 | TiO₂ | 120.0 |
| 40 | SiO₂ | 188.4 |
| 41 | TiO₂ | 120.0 |
| 42 | SiO₂ | 188.4 |
| 43 | TiO₂ | 120.0 |
| 44 | SiO₂ | 188.4 |
| 45 | TiO₂ | 120.0 |
| 46 | SiO₂ | 188.4 |
| 47 | TiO₂ | 120.0 |
| 48 | SiO₂ | 188.4 |

In one variant of the invention (not illustrated), the layers having a high optical refractive index are Nb₂O₅, Ta₂O₅, ZrO or Al₂O₃ layers.

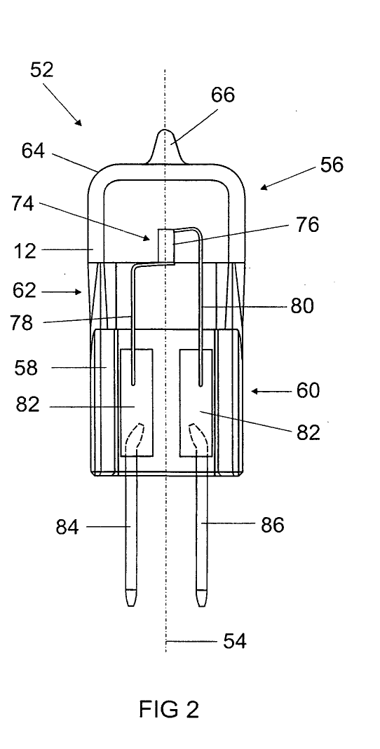

As shown in FIG. 2, which shows a reflector lamp 52 according to the invention with a side reflector, the halogen reflector lamp 52 has an essentially cylindrical lamp vessel 56, which consists of quartz glass and is rotationally symmetrical about a lamp longitudinal axis 54, a base 60 of the G4 type being formed at the lower (in FIG. 2) end section of said lamp vessel 56 by means of a pinch seal 58. The base 60 merges with the lamp vessel 56 via a lamp neck 62. That end section of the lamp vessel 56 which is remote from the base 60 is formed by a bowl 64, on which an exhaust tube attachment 66 is formed.

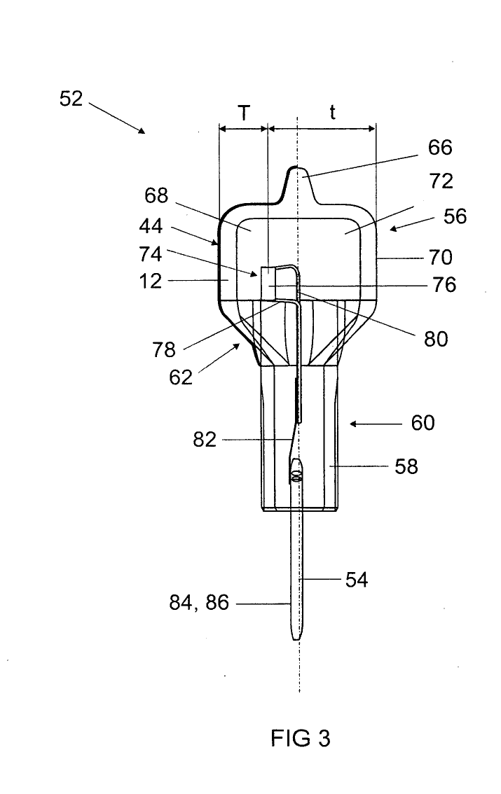

As can be seen in FIG. 3, which shows a side view of the halogen reflector lamp 52 from FIG. 2, a first half shell 68 of the lamp vessel 56 is provided with the reflective coating 44 (only indicated in FIG. 3 in order to be able to see the interior of the lamp) explained in FIG. 1 on an outer circumferential surface 70. A second half shell 72 of the lamp vessel 56 is designed to transmit light in the form of a light exit window and does not have a coating. In the exemplary embodiment shown, the plane of separation of the two half shells 68, 72 runs along the longitudinal axis 54 of the lamp vessel 56, with the result that the reflective coating 44 extends over 50 percent of the circumference of the lamp vessel 56 to virtually the entire height of the lamp vessel 56 from the base 60 up to the exhaust tube attachment 66. As a result, light shadowing owing to the reflective coating 44 is avoided and defined light emission of the lamp 52 is achieved transversely to the longitudinal axis 54 of the lamp vessel 56. The plane of separation between the coated and uncoated half shells 68, 72 can, in further variants, run at an acute angle to the longitudinal axis 54 of the halogen reflector lamp 52. Furthermore, the ratio between the coated proportion and the uncoated proportion of the surface of the lamp vessel 56 can be varied. A luminous means 74 is arranged in the lamp vessel 56, which luminous means 74 is in the form of an axially aligned incandescent filament 76 consisting of tungsten wire in the exemplary embodiment described, said incandescent filament 76 being offset parallel to the left, i.e. in the direction of the half shell 68, which is provided with the reflective coating 44, of the lamp vessel 56, with the result that the distance T from the reflective coating 44 is shorter than the distance t from the light exit window formed by the second half shell 72. The incandescent filament 76 is completely surrounded by the half shell 68 provided with the reflective coating 44, with the result that the incandescent filament 76 is completely covered by the reflective coating 44. In other words, a reflection region is formed by the interference filter coating 44, which region surrounds the incandescent filament 76 in sections at a distance and reflects the emitted light in the direction towards the light exit window 72, with the result that the angle of emission of the halogen reflector lamp 52 is limited therefore uniform irradiation of a predetermined area is made possible. As can be seen in particular in FIG. 2, the inner power supply lines 78, 80 of the filament 76 are formed directly by the two end sections of the filament wire and are welded in each case to a molybdenum foil 82, which is embedded in a gas-tight manner in the pinch seal 58 and, in turn, is connected to an outer power supply line 84, 86 consisting of molybdenum. The first end sections, which are welded to the molybdenum foil 82, of the outer power supply lines 84, 86 are in each case designed to be bent and flattened. The second end sections of the outer power supply lines 84, 86 are passed out of the pinch seal 58 in the form of contact pins.

In order to minimize an undesirable parasitic light emission of the base 60 and to further improve the degree of optical efficiency of the reflector lamp 52, the reflective coating 44 in one variant of the reflector lamp 52 (not illustrated), extends at least in sections as far as into a region of the base 60.

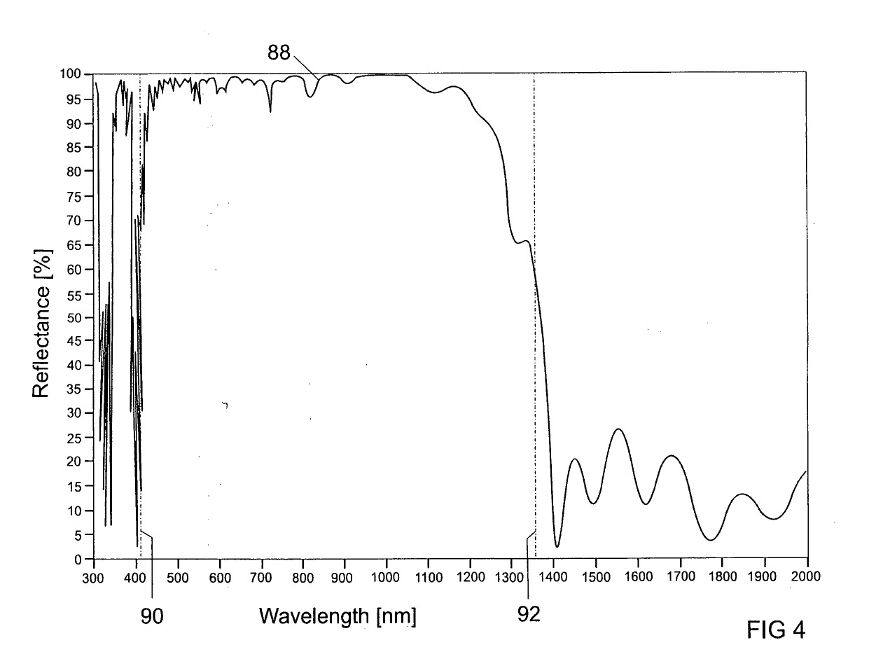

FIG. 4 illustrates the reflection properties of the interference filter coating 44 of the reflector lamps 1, 52 shown in FIGS. 1 to 3 by means of a curve 88. As shown by the curve 88, the reflective coating 44 of the lamp vessel 4, 56 in these exemplary embodiments is designed such that it reflects substantially the entire wavelength range of the radiation emitted by the incandescent filament 20, 76 up to a wavelength range of over 1100 nm (broadband mirror coating). For this purpose, the interference filter 44 is optimized such that a first filter edge 90 is at a wavelength of approximately 410 nm, and a high proportion of the radiation is emitted in the visible wavelength range of the lamp 1, 52, with the result that a high degree of optical efficiency of the reflector lamp 1, 52 is achieved. A second filter edge 92 of the interference filter 44 is in the infrared spectral range at a wavelength of approximately 1350 nm, as shown in FIG. 4. In the case of this solution which is suitable, for example, for recessed ceiling-mounted luminaires, the thermal load on the luminaire is reduced since the majority of the infrared portion of the radiation (thermal radiation) is reflected out of the luminaire.

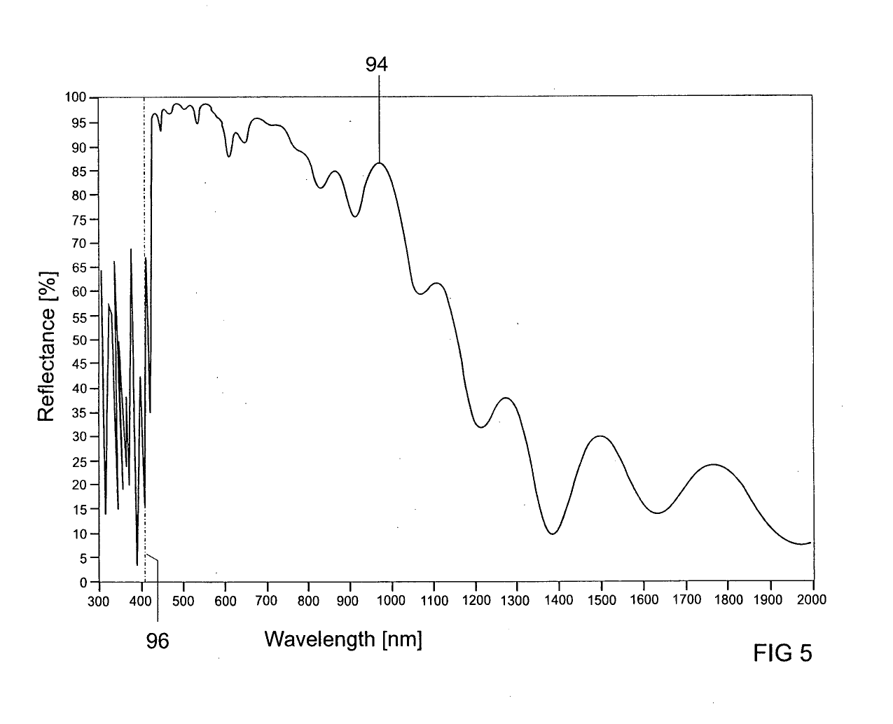

As shown in FIG. 5, which shows the reflection properties of a reflector lamp according to the invention (not illustrated) having an interference filter in the form of a medium mirror coating using a curve 94, the interference filter is in this case optimized such that the reflectance for light in the infrared wavelength range is, on average, less than 50%. A filter edge 96 is at a wavelength of approximately 410 nm, with the result that the reflective coating reflects a high proportion of the radiation in the visible wavelength range up to approximately 780 nm. As a result, the thermal radiation of the reflector lamp which is emitted by the reflective coating from the lamp vessel into the room is reduced, with the result that damage to thermally sensitive objects which radiation from the lamp strikes is prevented with only a low thermal load on the luminaire.

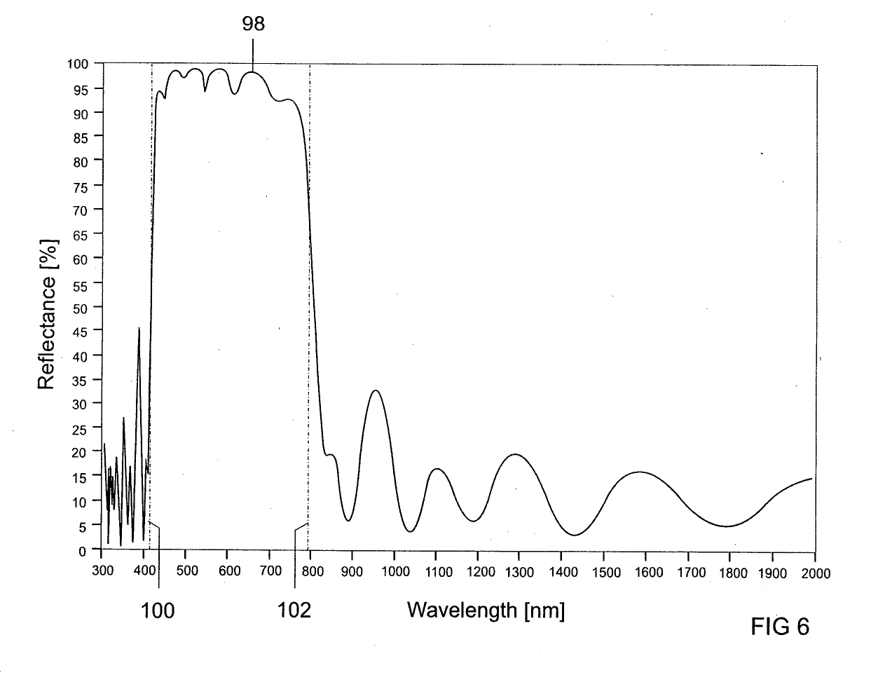

FIG. 6 illustrates the reflection properties of an interference filter coating in the form of a cold-light mirror coating in accordance with a further exemplary embodiment (not illustrated) of the reflector lamp by means of a curve 98. The interference filter is in this case optimized such that the reflectance for light in the infrared wavelength range is, on average, less than 20%, and the reflective coating substantially reflects radiation in a visible wavelength range up to approximately 780 nm. For this purpose, the interference filter is optimized such that a first filter edge 100 is at a wavelength of approximately 410 nm, and a second filter edge 102 is at approximately 800 nm. In this exemplary embodiment, the thermal radiation of the lamp emitted by the reflective coating from the lamp vessel into the room is further reduced since the reflective coating is largely pervious to thermal radiation, with the result that this thermal radiation can leave the reflector lamp towards the rear, i.e. in the direction of the base. As a result, damage owing to the thermal radiation emitted by the lamp is avoided even in the case of very thermally sensitive objects.

The invention is not restricted to the exemplary embodiments explained in more detail above; in particular, the invention can be used for incandescent lamps 1, 52 having any desired lamp vessel geometry and having different interference filter designs. Furthermore, other suitable materials and coating processes can be used for the interference layers. It is essential to the invention that the reflective coating 44 has an interference filter which is substantially impervious to light in the visible wavelength range and has defined transmission and reflection properties for light in the infrared wavelength range.

The invention discloses a reflector lamp 1, 52, in particular a halogen reflector lamp, having a light-transmitting lamp vessel 4, 56, in which at least one luminous means 18, 74 is accommodated, at least one vessel section 12, 68 of the lamp vessel 4, 56 being provided with a reflective coating 44. According to the invention, the reflective coating 44 has an interference filter, which is substantially impervious to light in the visible wavelength range and has defined transmission and reflection properties for light in the infrared wavelength range.

1. A reflector lamp, in particular a halogen reflector lamp, having a light-transmitting lamp vessel (4, 56), in which at least one luminous means (18, 74) is accommodated, at least one vessel section (12, 68) of the lamp vessel (4, 56) being provided with a reflective coating (44), characterized in that the reflective coating (44) has an interference filter, which is substantially impervious to light in the visible wavelength range and has defined transmission and reflection properties for light in the infrared wavelength range.

2. The reflector lamp as claimed in claim 1, the reflective coating (44) having an average reflectance of over 90% for light in the visible wavelength range.

3. The reflector lamp as claimed in claim 1, the reflective coating (44) being applied to the outer circumference (45, 70) of the vessel section (12, 68).

4. The reflector lamp as claimed in claim 1, the interference filter (44) having a plurality of layers having a low optical refractive index and layers having a high optical refractive index.

5. The reflector lamp as claimed in claim 4, the layers having a low optical refractive index being SiO₂ layers, and the layers having a high optical refractive index being TiO₂, Nb₂O₅, Ta₂O₅, ZrO or Al₂O₃ layers.

6. The reflector lamp as claimed in claim 1, the interference filter (44) being optimized such that a filter edge (90, 96, 100) is in a wavelength range of from approximately 360 nm to 440 nm, preferably at 410 nm.

7. The reflector lamp as claimed in claim 1, the interference filter (44) forming a broadband mirror coating, which is optimized such that a filter edge (92) is in the infrared wavelength range, in particular in a wavelength range of from 1200 nm to 1400 nm, preferably at 1350 nm.

8. The reflector lamp as claimed in claim 4, the layers having a low optical refractive index essentially having a layer thickness in the range of from approximately 80 nm to 190 nm, and the layers having a high optical refractive index essentially having a layer thickness in the range of from approximately 50 nm to 125 nm and being arranged alternately.

9. The reflector lamp as claimed in claim 8, the interference filter (44) having 48 layers.

10. The reflector lamp as claimed in claim 1, the interference filter (44) forming a medium mirror coating, which is optimized such that the reflectance for light in the infrared wavelength range is, on average, less than 50%.

11. The reflector lamp as claimed in claim 1, the interference filter (44) forming a cold-light mirror coating, which is optimized such that the reflectance for light in the infrared wavelength range is, on average, less than 20%.

12. The reflector lamp as claimed in claim 1, the luminous means (18, 74) having at least one incandescent filament (20, 76), which is aligned axially in the lamp vessel (4, 56).

13. The reflector lamp as claimed in claim 1, a sealed end section (6, 58) of the lamp vessel (4, 56) being in the form of a base (8, 60).

14. The reflector lamp as claimed in claim 13, the reflective coating (44) being arranged, in the form of an axial reflector, substantially annularly on a paraboloid vessel section (12), which adjoins the base (8), of the lamp vessel (4) and/or on the lamp neck (10).

15. The reflector lamp as claimed in claim 13, the reflective coating (44) extending at least in sections over longitudinal sides (48, 50) of the base (8).

16. The reflector lamp as claimed in claim 1, the reflective coating (44) extending, in the form of a lateral reflector, over a maximum of 50 percent of the circumference of the lamp vessel (56).

17. The reflector lamp as claimed in claim 16, the incandescent filament (76) being arranged parallel to the longitudinal axis (54) of the lamp vessel (56) such that it is offset in the direction of the reflective coating (44).

18. The reflector lamp as claimed in claim 16, the reflective coating (44) extending at least in sections as far as into a region of the base (60).

19. The reflector lamp as claimed in claim 2, the reflective coating (44) being applied to the outer circumference (45, 70) of the vessel section (12, 68).

20. The reflector lamp as claimed in claim 17, the reflective coating (44) extending at least in sections as far as into a region of the base (60).
